(19) United States
(12) Patent Application Publication
(10) Pub. No.: US 2010/0227288 A1
(43) Pub. Date: Sep. 9, 2010

(54) Fuel energy saving food cooker and water heater arrangement

(76) Inventor: Pei-De Li, Corona, NY (US)

Correspondence Address: DAVID AND RAYMOND PATENT FIRM, 108 N. YNEZ AVE., SUITE 128, MONTEREY PARK, CA, 91754, US

(21) Appl. No.: 12/381,015

(22) Filed: Mar. 5, 2009

Related U.S. Application Data
(63) Continuation-in-part of application No. 12/308,869, filed on Dec. 24, 2008.

(51) Int. Cl. F24H 1/22; A47J 27/10; F24H 9/02; F24H 9/20

(52) U.S. Cl. 432/29; 99/403; 122/19.2; 122/14.22

(57) ABSTRACT

A fuel energy saving water heater includes a food cooking apparatus, a heat collecting tank, and a water guider. The heat collecting tank includes an outer tank body and an inner tank body spacedly supported within the outer tank body to define the water chamber between the outer tank body and the inner tank body. The water guider is thermally communicated with the heat chamber, having a water chamber, a water outlet communicating with the water chamber, and a water inlet for operatively connecting to a water source. When a water flow is guided to pass through the water chamber from the water inlet to the water outlet, the water flow is heated by the excessive heat therewithin at a predetermined water temperature.

### CROSS-REFERENCE OF RELATED APPLICATION

This is a Continuation-In-Part application of a non-provisional application having an application No. 12/308,869 and a filing date of Dec. 24, 2008.

### BACKGROUND OF THE PRESENT INVENTION

1. Field of Invention

This present invention relates to a water heater, and more particularly to a water heater which is capable of heating up an amount of water by an excessive heat from a food cooking apparatus, such as an oil fryer, such that the water heater of the present invention is an environmental-friendly and a fuel energy saving device.

2. Description of Related Arts

Many people like to eat fried foods because of its tastes and favorites. Therefore, more and more food companies and restaurant provide fried food on the market. In order to achieve the fried food, those companies and restaurant need to use oil cooker or deep fryer to fry a huge amount of food. When frying the food, the oil cooker usually generates huge amount of heat and steam. And then the steam is usually discharged by the exhaust. Once the temperature of steam is too high, the exhaust channel will be overheated and broken very easily. As a result, the exhaust channel is needed to maintained, repaired, or replaced frequency. In addition, the steam is guided to exhaust directly to the environment. Therefore, the steam not only causes air pollution, but also is a waste of thermal.

On the other hand, as everyone knows, the water heater is an essential equipment in restaurants not only providing hot water, hot soups or drinks for their customers, but also forming a cooking apparatus to cook the food. Therefore, people have invented various kinds of heater to heat water and keep the water at a predetermined temperature. The size of the water heater is usually huge to fulfill the hot water demand for the restaurant.

In order to heat up the water from room temperature to around 90° C., the water heater has to consume huge amount of energy, such as gas or electric. On the other hand, since the water conducts and radiates its heat, the water temperature is kept decreasing at the same time. The water heater not only needs to heat water at high temperature, but also needs to keep it warm. For example, if the user wants to heat and keep 100 gallons of water at 90° C. for 24 hours, a predetermined power is the minimum electrical energy to be consumed. Not to mention if the water heater is not an energy saving device, it consumes more energy to maintain water at high temperature. To sum up, the heat output from the oil cooker and the energy transform and heat input for the water heater at the same room are a big waste of thermal energy.

### SUMMARY OF THE PRESENT INVENTION

The major object of the present invention is to provide a fuel energy saving cooker and water heater arrangement, which has a simple structure and design. It fully utilizes the heat generated by an oil cooker for heating up the water in the water tank so as to save energy, reduce exhaust, and protect the environment. Furthermore, the water heater can protect the exhaust channel of the oil cooker from being overheated or burnt by the steam.

Another object of the present invention is to provide a fuel energy saving cooker and water heater arrangement, which is designed to assure its operation safety.

Another object of the present invention is to provide a fuel energy saving cooker and water heater arrangement, wherein the fuel energy saving cooker and water heater arrangement combines the fuel energy saving cooker and water heater arrangement into a unity in such a manner that the volume of the whole appliance is much smaller and the material cost of the appliance is much lower either.

Accordingly, in order to accomplish the above object, the present invention provides a fuel energy saving cooker and a water heater arrangement wherein the heat collecting tank comprises an outer tank body and an inner tank body spacedly supported within the outer tank body to define the water chamber between the outer tank body and the inner tank body and to form the heat chamber within the inner tank body in such a manner that when the excessive heat passes through the heat chamber within the inner tank body, the water containing within the water chamber is heated up through the inner tank body.

The present invention further provides a fuel saving water heater for incorporating with a food cooking apparatus, comprising a heat collecting tank and a water guider.

A heat collecting tank has a heat chamber and a bottom heat energy inlet communicating with the heat chamber for operatively connecting to the food cooking apparatus to guide the excessive heat from the food cooking apparatus to the heat chamber.

A water guider is thermally communicated with the heat chamber, having a water chamber, a water outlet communicating with the water chamber, and a water inlet for operatively connecting to a water source, wherein when a water flow is guided to pass through the water chamber from the water inlet to the water outlet, the water flow is heated by the excessive heat therewithin at a predetermined water temperature.

The steam at a relatively high temperature produced by the oil cooker is guided to flow from food cooking apparatus to the heat chamber through the heat inlet. After the heat exchange between the water in the water tank and the steam at the heat chamber, the temperature of the steam will be dramatically dropped and the steam will then be discharged to the environment through upper heat outlet. The present invention utilizes the excessive heat from the oil cooker to heat the water in the water tank to minimize the use of other water heating apparatus so as to save the energy to heat the water and to decrease the temperature of the steam before the steam is discharged to the environment. Therefore, the water heater of the present invention is an environmental-friendly and an energy saving device. In addition, the present invention can protect the exhaust channel of the oil cooker from being overheated or burnt by the steam since the steam is cooled down after the heat exchange within the heat chamber.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a fuel energy saving cooker and water heater arrangement of a preferred embodiment of the present invention.

FIG. 2 is a side sectional view of the fuel energy saving cooker and water heater arrangement according to the above preferred embodiment of the present invention.

FIG. 3 is a top sectional view of the fuel energy saving cooker and water heater arrangement according to the above preferred embodiment of the present invention.

FIG. 4 is a sectional view of the fuel energy saving cooker and water heater arrangement according to the above preferred embodiment of the present invention, illustrating the reinforcing ribs of the present invention.

FIG. 5 is a front perspective view of a fuel energy saving cooker and water heater arrangement according to a second embodiment of the present invention.

FIG. 6 is a rear perspective view of the fuel energy saving cooker and water heater arrangement according to the above second embodiment of the present invention.

FIG. 7 is a side perspective view of the fuel energy saving cooker and water heater arrangement according to the above second embodiment of the present invention, illustrating the supplemental heater within the heat chamber.

FIG. 8 is a partially sectional view of the fuel energy saving cooker and water heater arrangement according to the above second embodiment of the present invention.

FIG. 9 is a side perspective view of the fuel energy saving cooker and water heater arrangement according to the above third embodiment of the present invention, illustrating the configuration of the water pipe within the heat chamber.

FIG. 10 is a sectional view of the fuel energy saving cooker and water heater arrangement according to the above third embodiment of the present invention, illustrating the configuration of the water pipe within the heat chamber.

FIG. 11 is a sectional view of the fuel energy saving cooker and water heater arrangement according to a fourth embodiment of the present invention, illustrating the heat collecting tank integrally built-in with the food cooking apparatus.

### DETAILED DESCRIPTION OF THE PREFERRED EMBODIMENT

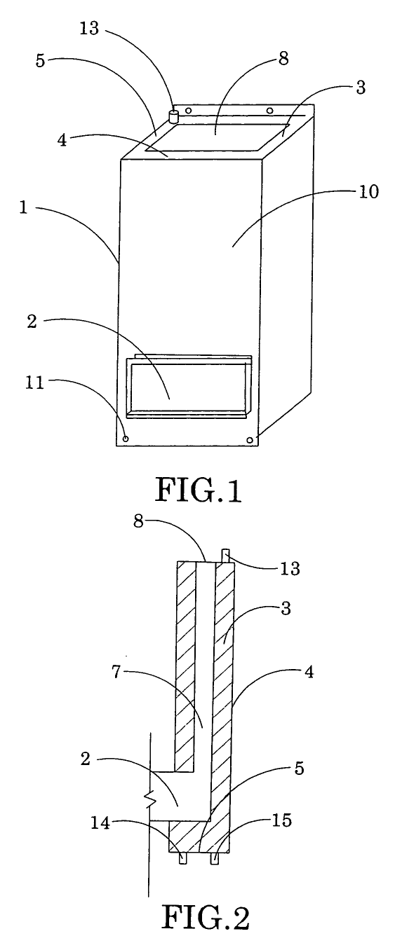

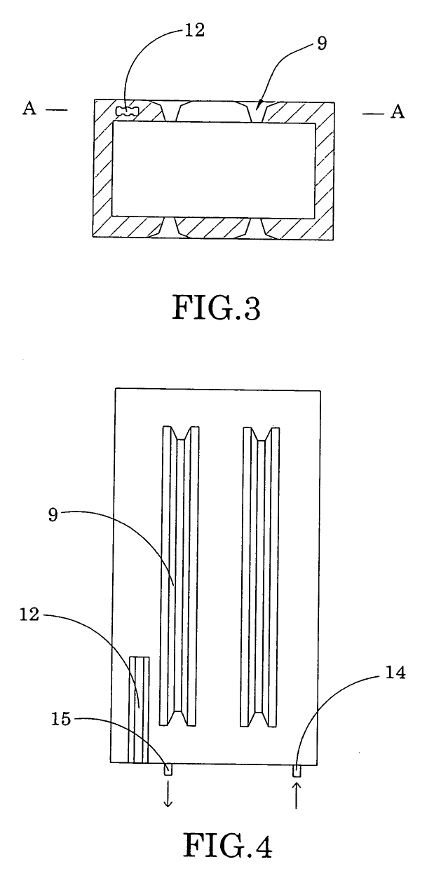

Referring to FIGS. 1 to 4 of the drawing, a fuel energy saving cooker and water heater arrangement according to a preferred embodiment of the present invention is illustrated, which comprises a water tank 1 communicatively linking to a food cooking apparatus, such as an oil fryer. The water tank 1 has a heat inlet 2 provided at a bottom portion to communicating with the food cooking apparatus. The water tank 1 further comprises an inner tank body 3 and an outer tank body to form a sealed water chamber 5 between the inner and outer tank bodies 3, 4. Each of the inner and outer tank bodies 3, 4 has a sealed base panel 6 to define the heat inlet 2 above the base panel 6, wherein the heat inlet 2 communicates with the heat chamber 5.

The outer tank body 4 further comprises a plurality of indented reinforcing ribs 9 built-in therewithin to enhance strength of the tank body and to extend the life span of the tank body. Furthermore, the reinforcing ribs 9, made of thermal conductive material, can evenly distribute the excessive heat within the heat chamber 5.

For better installation of the water heater, a screw hole 11 is provided at the side wall 10 of the outer tank body 4 thereof to engage with the steam outlet at the oil cooker.

For security and safety purpose, a safety valve 13 is provided for the sealed water chamber 5.

In order to discharge steam efficiently, the ventilating device, such as a fan, is mounted at the top side of the water tank 1 at the heat outlet 8 thereof.

The water tank 1 comprises a water inlet 14 and a water outlet 15 at the bottom portion of the water tank 1 to communicate with the water chamber 5.

The water tank 1 further comprises a supplemental heater 12, such as an electric heater, provided at the water chamber 5 for generating an additional heat therewithin, wherein the supplemental heater 12 is located adjacent to the water outlet 15 for ensuring the water in the water chamber 5 being heated up at a predetermined temperature before the water exits at the water outlet 15.

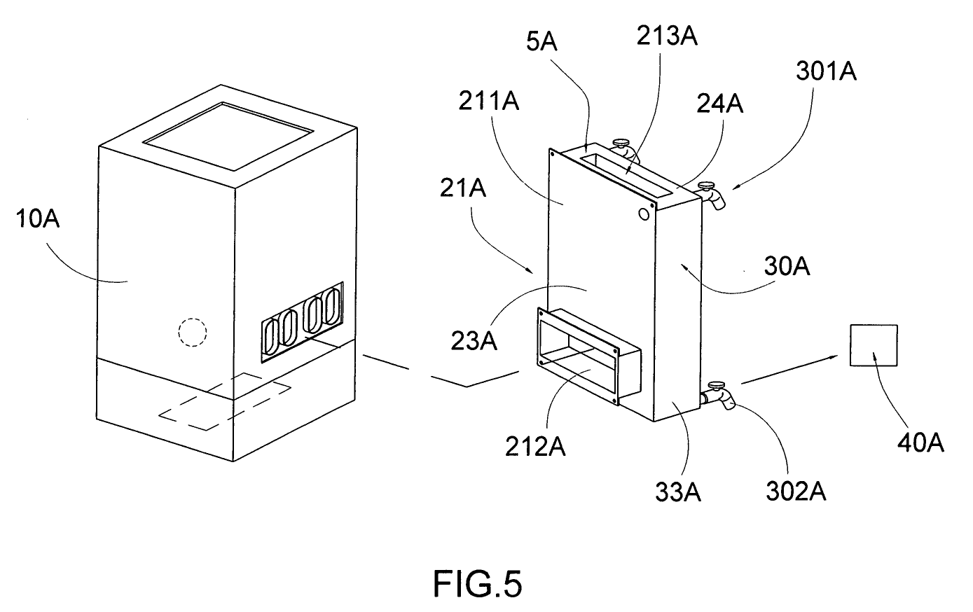

As shown in FIGS. 5 to 7 of the drawings, a fuel saving water heater for incorporating with the food cooking apparatus 10A according to a second embodiment is illustrated, wherein the fuel saving water heater comprises a heat collecting tank 21A and a water guider 30A. The food cooking apparatus 10A comprises a heat source adapted for generating heat energy with a relatively high temperature for cooking food and outputting an excessive heat during operation.

According to the second embodiment, a heat collecting tank 21A has a heat chamber 211A and a bottom heat energy inlet 212A communicating with the heat chamber 211A for operatively connecting to the food cooking apparatus 10A to guide the excessive heat from the food cooking apparatus 10A to the heat chamber 211A. Accordingly, the food cooking apparatus 10A can be an oil type deep fryer, oven, electric stove, or gas stove in which they are commonly utilized in the kitchen.

The water guider 30A, which is thermally communicated with the heat chamber 211A, has a water chamber 5A, a water outlet 301A communicating with the water chamber 5A, and a water inlet 302A for operatively connecting to a water source 40A, wherein when a water flow is guided to pass through the water chamber 5A from the water inlet 302A to the water outlet 301A, water flow is heated by the excessive heat therewithin at a predetermined water temperature. Accordingly, when the water passes into the water chamber 5A through the water inlet 302A, the water is heated by the excessive heat within the heat chamber 211A. In other words, the water chamber 5A and the heat chamber 211A are thermally communicated with each other for heat exchange so as to heat up the water within the water chamber 5A.

Accordingly, the heat collecting tank 21A has a rectangular shape defining a top wall 24A, a front wall 23A, a rear wall 32A, two sidewalls 33A, and a base wall 34A, wherein the heat chamber 5A is formed therewithin. For better installation of the water heater, a screw hole 35A is provided at the front wall 23A of the heat collecting tank 21A thereof to secure the bottom heat energy inlet 212A with the outlet of the food cooking apparatus 10A. For security and safety purpose, a safety valve 303A is provided for the water chamber 5A. The heat collecting tank 21A further has a heat releasing outlet 213A formed at the top wall 24A for operatively connecting to a chimney of the food cooking apparatus 10A. Therefore, the excessive heat will pass through the heat chamber 5A through the heat energy inlet 212A and will exit to the chimney of the food cooking apparatus 10A through the heat releasing outlet 213A.

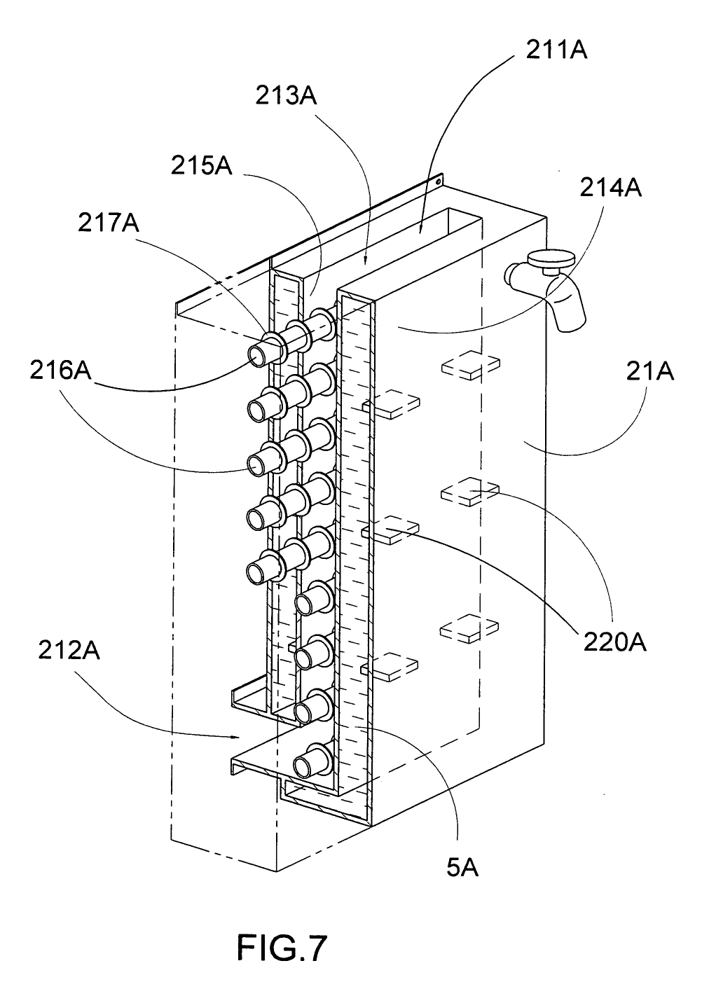

Referring to FIG. 7 of the drawings, the heat collecting tank 21A comprises an outer tank body 214A and an inner tank body 215A spacedly supported within the outer. tank body 214A to define the water chamber 5A between the outer tank body 214A and the inner tank body 215A and to form the heat chamber 211A within the inner tank body 215A in such a manner that when excessive heat passes through the heat chamber 211A within the inner tank body 215A, water containing within the water chamber 5A is heated up through the inner tank body 215A.

It is worth to mention that the outer tank body 214A is made of thermally insulated material for effectively maintaining excessive heat to heat up the water within the water chamber 5A, while the inner tank body 215A is made of thermally conductive material for effectively conducting excessive heat from the heat chamber 211A to the water chamber 5A.

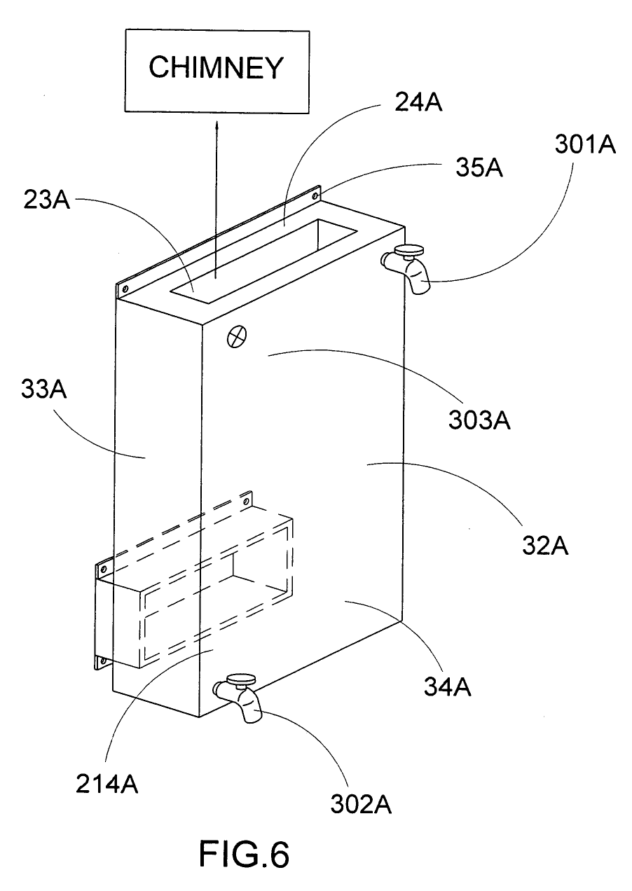

Referring to FIG. 6 of the drawings, the water inlet 302A is formed at a bottom portion of the outer tank body 214A and the water outlet 301A is formed at an upper portion of the outer tank body 214A to communicate with the water chamber 5A. Therefore, the water is filled up in the water chamber 5A from bottom to top for being effectively heated up by the excessive heat.

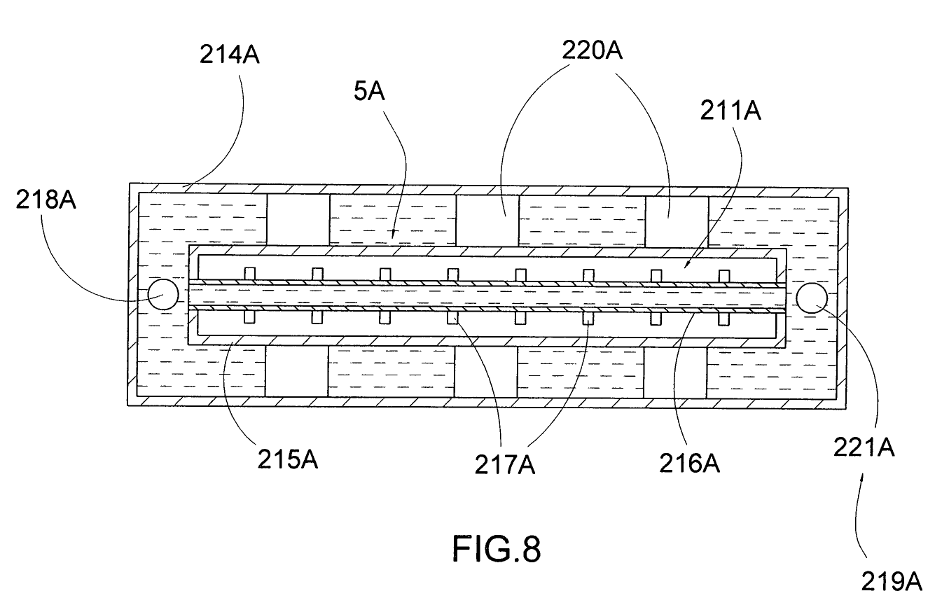

According to the preferred embodiment as shown in FIG. 8, the fuel saving water heater further comprises at least an elongated water tube 216A extended between two sidewalls of the inner tank body 215A respectively through the heat chamber 211A for heating up the water within the water tube 216A when the water passing through the water tube 216A from one side of the water chamber 5A to another side thereof. It is worth to mention that water can freely flow within the water chamber 5A from one side to another side through the water tube 216A such that the excessive heat can be evenly distributed to heat up the water at uniform temperature within the water chamber 5A.

The fuel saving water heater further comprise a plurality of conductive fins 217A spacedly supported along the water tube 216A within the heat chamber 211A, wherein the conductive fins 217A are adapted for thermally conducting the excessive heat within the heat chamber 211A to the water tube 216A so as to effectively heat up the water when the water passes along the water tube 216A.

Referring to FIG. 8 of the drawings, the heat collecting tank 21A further comprises a supplemental heater 218A supported within the water chamber 5A for generating additional heat energy therewithin for heating up the water passing through the water chamber 5A, and a water temperature sensor 219A operatively linked to the supplemental heater 218A to activate the supplemental heater 218A when the water temperature of the water is below a preset temperature.

The water temperature sensor 219A is adapted to detect the water temperature of the water pipe 303A. When the water is not heated up within the water pipe 303A by the excessive heat at a predetermined temperature, the water temperature sensor 219A will automatically activate the supplemental heater 218A for heat generation to heat up the water until the water temperature of the water within the water pipe 303A reaches the predetermined temperature, so as to ensure the hot water flowing out at the water outlet 301A. Accordingly, the water is preferably heated up around 90° C.

For example, the temperature sensor 219A, which is connected between the supplemental heater 218A and the water guider 30A, comprises a preset temperature controller 221A within the temperature sensor 219A with 90° C. for turning on and cutting off the power supply of the supplemental heater 218A. The temperature sensor 219A monitors the temperature of water in the water guider 30A in real-time. For example, when the temperature of water is lower than the preset temperature 90° C., the supplemental heater 218A turns on the power supply of the supplemental heater 218A to heat up water till 90° C. On the contrary, once the temperature of water is higher than the preset temperature 95° C., the supplemental heater 218A automatically deactivates the power switch of the supplemental heater 218A. Moreover, the user is able to set the saving energy mode other than the office hour to turns off the supplemental heater 218A for save more energy.

In other words, when the water temperature within the water guider 30A increases from the room temperature to 70° C. as an example by the excessive heat, the temperature sensor will automatically activate the supplemental heater 218A to heat up the water from 70° C. to 90° C. Therefore, the energy consumed by the supplemental heater 218A will be substantially reduced in comparison with the conventional water heater for heating up the water from room temperature to 90° C.

The heat collecting tank 21A further comprises a plurality of reinforcing ribs 220A spacedly supported between the outer tank body 214A and the inner tank body 215A to enhance the strength of the heat collecting tank 21A. The reinforcing ribs 220A can be embodied as an expandable element such that when the excessive heat is accumulated within the heat chamber 211A, the heat collecting tank 21A can be slightly self-expanded correspondingly to prevent the damage of the heat collecting tank 21A by means of over-expansion. Accordingly, the reinforcing ribs 220A are indented within the walls of the heat collecting tank 21A and are capable of improving strength of the tank body and to extend the life span of the tank body.

A method for heating up water from excessive heat of a food cooking apparatus 10A, comprising the steps of:

(a) operatively connecting the heat energy inlet 212A of the heat collecting tank 21A to the food cooking apparatus 10A to guide excessive heat from the food cooking apparatus 10A to a heat chamber of the heat collecting tank 21A through the heat energy inlet 212A;

(b) guiding the water flow to pass from the water inlet 302A of the water guider 30A to the water outlet 301B thereof through the water chamber 5A of the water guider 30A; and

(c) thermally conducting the water guider 30A with the heat chamber 211A by the excessive heat to heat up the water passing through the water guider 30A at a predetermined water temperature.

In the step (a), the heat energy inlet 212A of the heat collecting tank 21A is connected to a heat exhaust of a heat source of the food cooking apparatus 10B.

In the step (a), the heat energy inlet 212A of the heat collecting tank 21A further comprises the steps of:

(a.1) generating additional heat energy within the heat chamber 211B by the supplemental heater 211B to heat up the water passing through the water guider 30A; and

(a.2) controllably activating the supplemental heater 211A via the water temperature sensor 25A when the water temperature of the water within the water guider 30A is below a preset temperature.

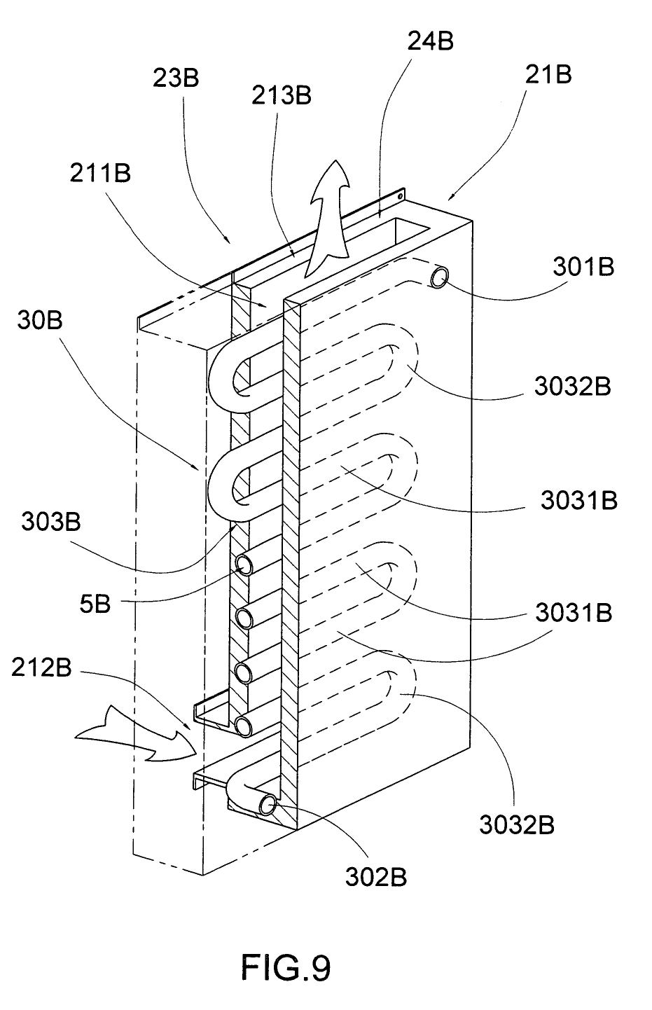

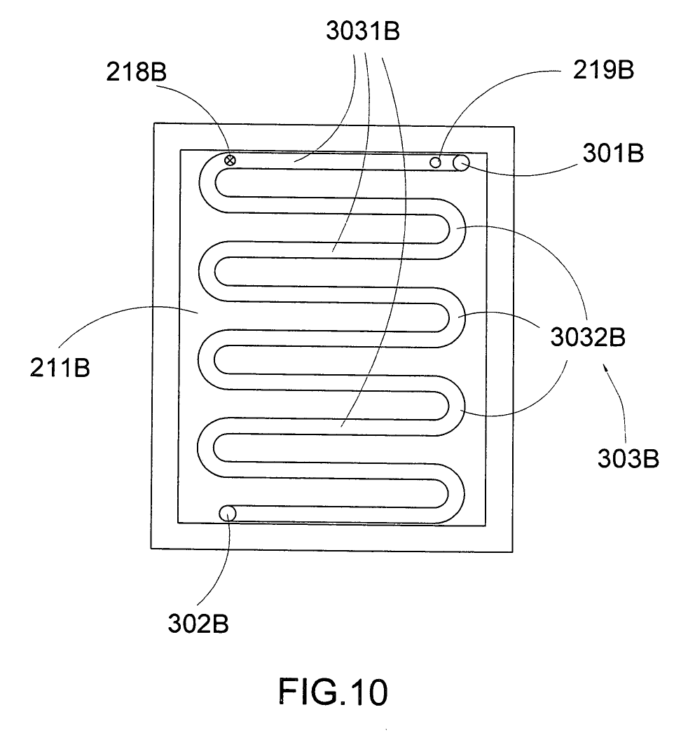

According to the third preferred embodiment of the present invention as shown in FIG. 9, the water guider 30B comprises an elongated water pipe 303B, which is made of thermally conductive material, defining the water chamber 5B therewithin, wherein the water pipe 303B is extended within the heat chamber 211B for thermally conducting excessive heat within the heat chamber 211B to the water pipe 303B.

The water inlet is formed one end of the water pipe 302B located at a bottom portion of the heat collecting tank 21B and the water outlet 301B is formed at an opposed end of the water pipe 302B located at an upper portion of the heat collecting tank 21B.

Referring to FIG. 9 of the drawings, the water pipe 303B has a plurality of parallel pipe sections 3031B longitudinally and spacedly supported within the heat chamber 211B and a plurality of cornering pipe sections 3032B operatively coupling with parallel pipe sections 3031A, such that the water flow is guided to pass through the water pipe 303B in a zigzag manner for being effectively heated up within the heat chamber 211B. The heat collecting tank 21B comprises a front wall 23B defining the heat energy inlet 212B thereat and a top wall 24B defining a heat releasing outlet 213B thereat for releasing excessive heat from the heat chamber 211B.

The heat collecting tank 21B is made of heat insulated material for effectively maintaining excessive heat to heat up the water passing through the water guider 30B. The water guider 30B within the heat chamber 211B is thermally communicated with each other for heat exchange so as to heat up the water within the water guider 30B.

The heat collecting tank further comprises a supplemental heater 218B operatively coupled at the water pipe 303B for generating additional heat energy within the water chamber 5B for heating up the water passing through the water pipe 303B. A water temperature sensor 219B operatively linked to the supplemental heater 218B to activate the supplemental heater 218B when the water temperature of the water is below a preset temperature.

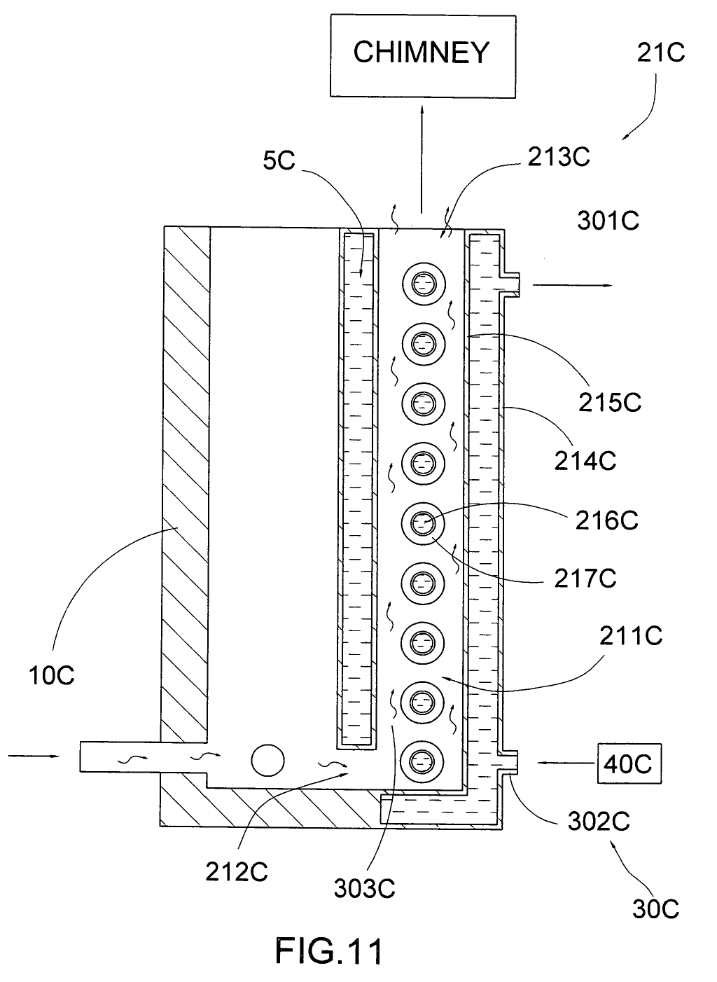

FIG. 11 illustrates a fourth alternative mode of the fuel energy saving cooker and water heater arrangement. The difference between the fourth alternative mode and the preferred embodiment is that the fourth alternative mode combines the fuel energy saving cooker and water heater arrangement into a unity in such a manner that the volume of the whole appliance is much smaller and the material cost of the appliance is much lower either. Accordingly, the rear wall of the food cooking apparatus 10A is integrally formed with the front wall 23C of the heat collecting tank 21C to communicate the heat energy inlet 212C with the outlet of the food cooking apparatus 10C such that the excessive heat from the food cooking apparatus is directly passing into the heat collecting tank 21C.

Accordingly, the heat collecting tank 21C has a heat chamber 211C and a bottom heat energy inlet 212C communicating with the heat chamber 211C and extending from the food cooking apparatus 10C to guide the excessive heat from the food cooking apparatus 10C to the heat chamber 211C. Accordingly, the heat collecting tank 21C further has a heat releasing outlet 213C operatively connecting to a chimney of the food cooking apparatus 10C.

The water guider 30C, which is thermally communicated with the heat chamber 211C, has a water chamber 5C, a water outlet 301C communicating with the water chamber 5C, and a water inlet 302C for operatively connecting to a water source 40C, wherein when a water flow is guided to pass through the water chamber 5C from the water inlet 302C to the water outlet 301C, water flow is heated by the excessive heat therewithin at a predetermined water temperature. Accordingly, when the water passes into the water chamber 5C through the water inlet 302C, the water is heated by the excessive heat within the heat chamber 211C.

The heat collecting tank 21C comprises an outer tank body 214C and an inner tank body 215C spacedly supported within the outer tank body 214C to define the water chamber 5C between the outer tank body 214C and the inner tank body 215C and to form the heat chamber 211C within the inner tank body 215C in such a manner that when excessive heat passes through the heat chamber 211C within the inner tank body 215C, water containing within the water chamber 5C is heated up through the inner tank body 215C.

The fuel saving water heater further comprises at least an elongated water tube 216C extended between two sidewalls of the inner tank body 215C respectively through the heat chamber 211A for heating up the water within the water tube 216C when the water passing through the water tube 216C from one side of the water chamber 5C to another side thereof. It is worth to mention that water can freely flow within the water chamber 5C from one side to another side through the water tube 216C such that the excessive heat can be evenly distributed to heat up the water at uniform temperature within the water chamber 5C.

The fuel saving water heater further comprise a plurality of conductive fins 217C spacedly supported along the water tube 216C within the heat chamber 211C, wherein the conductive fins 217C are adapted for thermally conducting the excessive heat within the heat chamber 211C to the water tube 216C so as to effectively heat up the water when the water passes along the water tube 216C.

The water guider 30C comprises an elongated water pipe 303C, which is made of thermally conductive material, defining the water chamber 5C therewithin, wherein the water pipe 303C is extended within the heat chamber 211C for thermally conducting the excessive heat within the heat chamber 211C to the water pipe 303C.

Accordingly, the heat collecting tank 21CA can further incorporate with the supplemental heater 218A supported within the water chamber 5C for generating additional heat energy therewithin for heating up the water passing through the water chamber 5C, and a water temperature sensor 219A operatively linked to the supplemental heater 218A to activate the supplemental heater 218A when the water temperature of the water is below a preset temperature, as shown in the second embodiment.

To sum up, the water heater fully utilizes the heat generated by an oil cooker for heating up the water in the water tank so as to save energy, reduce exhaust, and protect the environment. Furthermore, the water heater can protect the exhaust channel of the oil cooker from being overheated or burnt by the steam.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fuel energy saving water heater arrangement for installing to a food cooking apparatus which outputs an excessive heat during operation, comprising:
a heat collecting tank having a heat chamber and a bottom heat energy inlet communicating with said heat chamber for operatively connecting to the food cooking apparatus to guide the excessive heat from the food cooking apparatus to said heat chamber; and
a water guider, which is thermally communicated with said heat chamber, having a water chamber, a water outlet communicating with said water chamber, and a water inlet for operatively connecting to a water source, wherein when a water flow is guided to pass through said water chamber from said water inlet to said water outlet, said water flow is heated by the excessive heat therewithin at a predetermined water temperature.

2. The fuel energy saving water heater arrangement, as recited in claim 1, wherein said heat collecting tank comprises an outer tank body and an inner tank body spacedly supported within said outer tank body to define said water chamber between said outer tank body and said inner tank body and to form said heat chamber within said inner tank body in such a manner that when the excessive heat passes through said heat chamber within said inner tank body, said water containing within said water chamber is heated up through said inner tank body.

3. The fuel energy saving water heater arrangement, as recited in claim 2, wherein said outer tank body is made of thermally insulated material for effectively maintaining the excessive heat to heat up said water within said water chamber, while said inner tank body is made of thermally conductive material for effectively conducting the excessive heat from said heat chamber to said water chamber.

4. The fuel energy saving water heater arrangement, as recited in claim 2, wherein said water inlet is formed at a bottom portion of said outer tank body and said water outlet is formed at an upper portion of said outer tank body to communicate with said water chamber.

5. The fuel energy saving water heater arrangement, as recited in claim 3, wherein said water inlet is formed at a bottom portion of said outer tank body and said water outlet is formed at an upper portion of said outer tank body to communicate with said water chamber.

6. The fuel energy saving water heater arrangement, as recited in claim 2, further comprising at least an elongated water tube extended between two sidewalls of said inner tank body respectively through said heat chamber for heating up said water within said water tube when said water passing through said water tube from one side of said water chamber to another side thereof.

7. The fuel energy saving water heater arrangement, as recited in claim 5, further comprising at least an elongated water tube extended between two sidewalls of said inner tank body respectively through said heat chamber for heating up said water within said water tube when said water passing through said water tube from one side of said water chamber to another side thereof.

8. The fuel energy saving water heater arrangement, as recited in claim 6, further comprising a plurality of conductive fins spacedly supported along said water tube within said heat chamber, wherein said conductive fins are adapted for thermally conducting the excessive heat within said heat chamber to said water tube so as to effectively heat up said water passing along said water tube.

9. The fuel energy saving water heater arrangement, as recited in claim 7, further comprising a plurality of conductive fins spacedly supported along said water tube within said heat chamber, wherein said conductive fins are adapted for thermally conducting the excessive heat within said heat chamber to said water tube so as to effectively heat up said water passing along said water tube.

10. The fuel energy saving water heater arrangement, as recited in claim 1, wherein said heat collecting tank comprises a front wall defining said heat energy inlet thereat and a top wall defining a heat energy outlet thereat for releasing the excessive heat from said heat chamber.

11. The fuel energy saving water heater arrangement, as recited in claim 5, wherein said heat collecting tank comprises a front wall defining said heat energy inlet thereat and a top wall defining a heat energy outlet thereat for releasing the excessive heat from said heat chamber.

12. The fuel energy saving water heater arrangement, as recited in claim 9, wherein said heat collecting tank comprises a front wall defining said heat energy inlet thereat and a top wall defining a heat energy outlet thereat for releasing the excessive heat from said heat chamber.

13. The fuel energy saving water heater arrangement, as recited in claim 1, wherein said heat collecting tank further comprises a supplemental heater supported within said water chamber for generating additional heat energy therewithin for heating up said water passing through said water chamber, and a water temperature sensor operatively linked to said supplemental heater to activate said supplemental heater when said water temperature of said water is below a preset temperature.

14. The fuel energy saving water heater arrangement, as recited in claim 5, wherein said heat collecting tank further comprises a supplemental heater supported within said water chamber for generating additional heat energy therewithin for heating up said water passing through said water chamber, and a water temperature sensor operatively linked to said supplemental heater to activate said supplemental heater when said water temperature of said water is below a preset temperature.

15. The fuel energy saving water heater arrangement, as recited in claim 12, wherein said heat collecting tank further comprises a supplemental heater supported within said water chamber for generating additional heat energy therewithin for heating up said water passing through said water chamber, and a water temperature sensor operatively linked to said supplemental heater to activate said supplemental heater when said water temperature of said water is below a preset temperature.

16. The fuel energy saving water heater arrangement, as recited in claim 2, wherein said heat collecting tank further comprises a plurality of reinforcing ribs spacedly supported between said outer tank body and said inner tank body to enhance a strength of said heat collecting tank.

17. The fuel energy saving water heater arrangement, as recited in claim 15, wherein said heat collecting tank further comprises a plurality of reinforcing ribs spacedly supported between said outer tank body and said inner tank body to enhance a strength of said heat collecting tank.

18. The fuel energy saving water heater arrangement, as recited in claim 1, wherein said water guider comprises an elongated water pipe, which is made of thermally conductive material, defining said water chamber therewithin, wherein said water pipe is extended within said heat chamber for thermally conducting the excessive heat within said heat chamber to said water pipe.

19. The fuel energy saving water heater arrangement, as recited in claim 18, wherein said water inlet of said water pipe is located at a bottom portion of said heat collecting tank and said water outlet located at an upper portion of said heat collecting tank.

20. The fuel energy saving water heater arrangement, as recited in claim 19, wherein said water pipe has a plurality of parallel pipe sections longitudinally and spacedly supported within said heat chamber and a plurality of cornering pipe sections operatively coupling with parallel pipe sections, such that said water flow is guided to pass through said water pipe in a zigzag manner for being effectively heated up within said heat chamber.

21. The fuel energy saving water heater arrangement, as recited in claim 20, wherein said heat collecting tank comprises a front wall defining said heat energy inlet thereat and a top wall defining a heat energy outlet thereat for releasing the excessive heat from said heat chamber.

22. The fuel energy saving water heater arrangement, as recited in claim 21, wherein said heat collecting tank is made of heat insulated material for effectively maintaining the excessive heat to heat up said water passing through said water guider.

23. The fuel energy saving water heater arrangement, as recited in claim 1, wherein said heat collecting tank further comprises a supplemental heater operatively coupled at said water pipe for generating additional heat energy within said water chamber for heating up said water passing through said water pipe, and a water temperature sensor operatively linked to said supplemental heater to activate said supplemental heater when said water temperature of said water is below a preset temperature.

24. A method for heating up water from excessive heat of a food cooking apparatus, comprising the steps of:
(a) operatively connecting a heat energy inlet of a heat collecting tank to said food cooking apparatus to guide said excessive heat from said food cooking apparatus to a heat chamber of said heat collecting tank through said heat energy inlet;
(b) guiding a water flow to pass from a water inlet of a water guider to a water outlet thereof through a water chamber of said water guider; and
(c) thermally conducting said water guider with said heat chamber by said excessive heat to heat up said water passing through said water guider at a predetermined water temperature.

25. The method as recited in claim 24 wherein, in the step (a), said heat energy inlet of said heat collecting tank is connected to an heat exhaust of a heat source of said food cooking apparatus.

26. The method, as recited in claim 24, further comprising the steps of:
generating additional heat energy within said heat chamber by a supplemental heater to heat up said water passing through said water guider; and
controllably activating said supplemental heater via a water temperature sensor when said water temperature of said water within said water guider is below a preset temperature.

27. The method, as recited in claim 26, wherein said heat collecting tank comprises an outer tank body and an inner tank body spacedly supported within said outer tank body to define said water chamber between said outer tank body and said inner tank body and to form said heat chamber within said inner tank body in such a manner that when said excessive heat passes through said heat chamber within said inner tank body, said water containing within said water chamber is heated up through said inner tank body.

28. The method, as recited in claim 26, wherein said water guider comprises an elongated water pipe, which is made of thermally conductive material, defining said water chamber therewithin, wherein said water pipe is extended within said heat chamber for thermally conducting said excessive heat within said heat chamber to said water pipe.

29. The method, as recited in claim 27, wherein said heat collecting tank further has a heat releasing outlet operatively connecting to a chimney of said food cooking apparatus.

30. The method, as recited in claim 28, wherein said heat collecting tank further has a heat releasing outlet operatively connecting to a chimney of said food cooking apparatus.
